(19) United States
(12) Patent Application Publication
(10) Pub. No.: US 2003/0163831 A1
(43) Pub. Date: Aug. 28, 2003

(54) Field technician communicator

(76) Inventors: Donald T. Gall, Port Aransas, TX (US); David M. Pangrac, Port Aransas, TX (US)

Correspondence Address: Gary R. Stanford, Law Offices of Gary R. Stanford, 610 West Lynn, Austin, TX, 78703, US

(21) Appl. No.: 10/274,498

(22) Filed: Oct. 18, 2002

Related U.S. Application Data
(60) Provisional application No. 60/348,039, filed on Oct. 19, 2001.

(51) Int. Cl. H04N 7/173

(52) U.S. Cl. 725/127; 725/128; 725/129; 725/133

(57) ABSTRACT

A hand-held cable communicator unit for technicians that enables voice and data communications across a cable network. The communicator includes a cable connector, a diplex filter, a transceiver circuit, an audio circuit and a control circuit. The transceiver circuit tunes to selected downstream and upstream channels signals. The audio circuit enables bidirectional voice communications using the selected channels signals via the cable network. The control circuit establishes a communication link and initiates and terminates communications. A communication system for field technicians of a cable network includes at least one communicator and a central communicator located at a point of distribution of the cable network. The central communicator includes transceivers, a switch matrix and a controller. Each central transceiver establishes a communication link with any linked communicator. The switch matrix forwards upstream and downstream communications between linked communicators. The controller performs functions to establish communication connections.

### CROSS-REFERENCE TO RELATED APPLICATION(S)

The present application is based on U.S. provisional patent application entitled “Field Technician Communicator”, serial No. 60/348,039, filed Oct. 19, 2001, which is hereby incorporated by reference in its entirety.

### FIELD OF THE INVENTION

The present invention relates to field technician communications, and more particularly, to a field technician communicator that enables field technicians to establish communications on cable-based networks.

### DESCRIPTION OF RELATED ART

Cable modem systems utilize the television broadcast spectrum and television technology to broadcast broadband data to subscribers and to provide other cable services via a cable plant, such as a hybrid fiber coax (HFC) cable network or the like. The television data delivery systems have been established to deliver data to subscribers over a television broadcast spectrum extending up to approximately 1 Gigahertz (GHz). In some cable plans, analog television is delivered downstream to the subscriber within the spectrum between approximately 54 to 550 Megahertz (MHz). The remaining spectrum may be used for the delivery of digital information, such as using cable modem systems. The frequency location of the diplex filter separating the downstream from the upstream depends on the particular frequency plan in place. An extended sub-split frequency plan is defined in which the diplex filter is located within the frequency range of approximately 42 to 54 MHz, which is common for many consumer-based HFC systems. Diplexers allow for bi-directional communication over the shared HFC fiber and coaxial medium using Frequency Division Multiplexing (FDM). The basic diplexer consists of a high pass and a low pass filter in parallel followed by an amplifier that are both driven from the same source. In the extended sub-split frequency plan, which is typical for many consumer-based HFC systems, the two effective delivery frequency ranges using are those between approximately 5-42 MHz (upstream) and those between approximately 550-860 MHz (downstream).

Data-Over-Cable Service Interface Specifications (DOCSIS) is a defacto standard that specifies the methodology for delivering data services over an HFC plant. DOCSIS defines a Cable Modem Termination System (CMTS), which is an entity used to deliver data services over an HFC network from a central distribution point. These legacy systems use a shared frequency channel to broadcast all data to every downstream subscriber. The shared channel is generally 6 MHz wide providing a total data bandwidth of approximately 27-38 megabits per second (Mbps) for digital information.

A significant issue for any cable system is support and maintenance. Field technicians are often deployed to inspect and upgrade the cable plant and also to troubleshoot problems reported by subscribers of cable services. Problems may exist anywhere along the cable plant including Customer Premises Equipment (CPE) located at subscriber's homes. The field technician must not only have the appropriate equipment to assess the health and status of the cable plant including its active devices, but must also to communicate with other field technicians and/or the “home office” in order to resolve problems and issues, update subscriber information and close out trouble tickets. Existing communication methods are limited. Subscribers usually have telephones, but it is preferable that technicians not use subscriber telephones for various reasons. Cellular phones may be issued, but are relatively expensive to deploy for all field technicians, are primarily suitable for low-bandwidth voice communications and typically do not allow conferences or 3-way calls. Also, it is very difficult to regulate usage of cell phones. Further, cell phones only allow voice communications. Many technicians use Very High Frequency (VHF) radios, which may either be installed within service vehicles or implemented as portable or hand-held units. VHF radios, however, must be licensed and maintained to meet Federal Communications Commission (FCC) requirements. Also, VHF radios are relatively expensive and are limited to voice communications.

It is desired to provide a convenient method and system for enabling technician voice and data communications, especially while in the field servicing subscribers or troubleshooting cable plant problems.

### BRIEF DESCRIPTION OF THE DRAWINGS

For a more complete understanding of the present invention, reference is now made to the following description taken in conjunction with the accompanying drawings in which like reference numerals indicate like features and wherein:

FIG. 1 is a block diagram of a communication system according to an exemplary network architecture.

FIG. 2 is a simplified view of the communication system of FIG. 1 illustrating interface of a central technician communicator and field technician communicators configured according to embodiments of the present invention.

FIG. 3 is a block diagram of an exemplary embodiment of the central communicator of FIG. 2.

FIG. 4 is a block diagram of an exemplary embodiment of a tech communicator of FIG. 2.

FIG. 5 is a simplified flowchart diagram illustrating operation of the central communicator according to an embodiment of the present invention for establishing communication links with tech communicators.

FIG. 6 is a simplified flowchart diagram of operation of the control block of FIG. 3 for establishing communication connections between the tech communicators and with other devices.

FIG. 7 is a flowchart diagram illustrating power up and initial operation of the tech communicator for establishment of a communication link with the central communicator.

### DETAILED DESCRIPTION OF EMBODIMENTS OF THE INVENTION

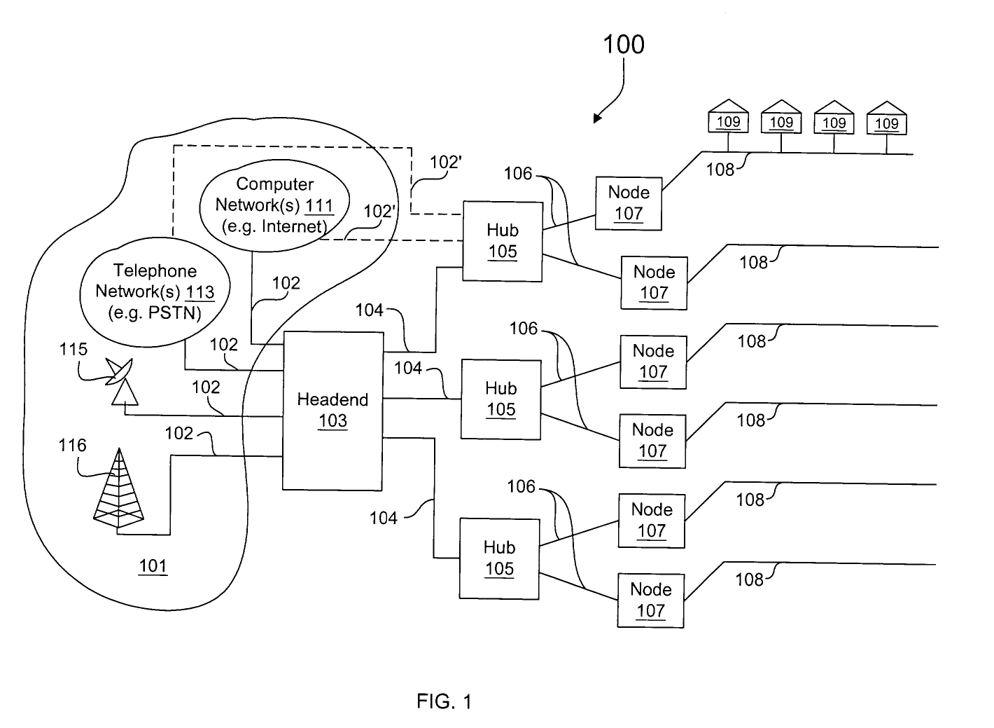

FIG. 1 is a block diagram of a communication system 100 according to an exemplary network architecture. One or more sources 101 are coupled via appropriate communication links 102 to deliver source information to a headend 103, which further distributes the source information downstream to one or more distribution hubs 105 via respective communication links 104. Each distribution hub 105 further distributes source information to one or more nodes 107 via communication links 106, where each node 107 in turn distributes the source information to one or more subscriber locations 109 via subscriber medium links 108. In the embodiment shown, bidirectional communication is supported in which subscriber information from any one or more of the subscriber locations 109 is forwarded upstream to a corresponding distribution hub 105. Depending upon the type of subscriber information and the architecture implementation, the subscriber information may further be forwarded by a distribution hub 105 to an appropriate source 101, either directly or via the headend 103.

It is noted that the headend 103, the distribution hubs 105 and the nodes 107 may generically be referred to as points of distribution for source and subscriber information. Each point of distribution supports a successively smaller geographic area. The headend 103, for example, may support a relatively large geographic area, such as an entire metropolitan area or the like, which is further divided into smaller areas, each supported by a distribution hub 105. The area supported by each distribution hub 105 is further divided into smaller areas, such as neighborhoods within the metropolitan area, each supported by a corresponding node 107.

Many different types of sources 101 are contemplated, such as one or more computer networks 111, one or more telephone networks 113, one or more satellite communication systems 115, one or more off-air antenna systems 116 (e.g. microwave tower), etc. The computer networks 111 may include any type of local area network (LAN), wide area network (WAN) or global computer network, such as including the Internet or the like. The telephone networks 113 may include the public switched telephone network (PSTN). The satellite communication systems 115 and/or the antenna systems 116 may be employed for reception and delivery of any type of information, such as television broadcast content or the like. The headend 103 may also include video on demand (VOD) equipment (not shown). Depending upon particular configurations, any one or more of the sources 101 may be coupled directly to one or more of the distribution hubs 105 in the alternative or in addition to being coupled to the headend 103 as illustrated by communication links 102′. For example, one or more of the computer networks 111 and the telephone networks 113 are shown coupled to a distribution hub 105 in addition or in the alternative. The headend 103 includes appropriate equipment for data transmission, such as, for example, internal servers, firewalls, IP routers, signal combiners, channel re-mappers, etc.

Each of the communication links (102, 102′, 104, 106, 108) may be any appropriate type of medium, such as electrical or fiber optic cables or the like, or any combination of mediums, such as including both electrical and optical media or multiple optical media, etc. For example, in one embodiment, each of the communication links 102 and 102′ includes optical media for communicating analog optical information, such as between the headend 103 and a satellite communication system 115 or an antenna system 116, and/or 1000Base-X Ethernet for communicating digital data and information between the headend 103 and any computer or telephone network 111, 113. Also, the communication links 106 comprise optical fibers or cables that are distributed between each node 107 and a corresponding distribution hub 105. The network architecture may employ a hybrid fiber coax (HFC) distribution network in which the subscriber medium links 108 comprise coaxial cables that are distributed from each node 107 to the respective subscriber locations 109. In this configuration, the nodes 107 are optical nodes for conversion between optical and electrical formats. The communication links 104 may also comprise optical links, such as, for example, SONET (Synchronous Optical Network) rings or the like. It is understood that any known or future developed media is contemplated for each communication link. In an HFC embodiment, for example, each node 107 receives an optical signal from an upstream point of distribution, converts the optical signal to a combined electrical signal and distributes the combined electrical signal over a coaxial cable to each of several subscriber locations 109 of a corresponding geographic serving area. Subscriber information is forwarded in electrical format (e.g., radio frequency (RF) signals) and combined at each node 107, which forwards a combined optical signal upstream to a corresponding one of the distribution hubs 105 via respective communication links 106.

Each subscriber location 109 includes customer premises equipment (CPE) (not shown), such as set-top boxes or cable modems or the like that tunes, decodes, and demodulates source information from the combined electrical signal addressed or otherwise intended for the particular subscriber location 109. The CPE at each subscriber location 109 may include a modulating device or the like that encodes, modulates and up converts subscriber information into RF signals. The upstream RF signals from each of the subscriber locations 109 are transmitted on a subscriber medium 108 to a corresponding node 107. A separate upstream channel of the upstream portion of the cable spectrum used for upstream communications may be assigned to each of the subscriber locations 109 to prevent interference with downstream communications. The upstream RF signals are provided to the node 107, which includes an upstream optical transceiver or the like that converts the subscriber RF signals to an optical signal. For example, laser in the node 107 may be used to convert the return signal to an optical signal and send the optical return signal to an optical receiver at the distribution hub 105 over another fiber optic cable.

The source and subscriber information may include any combination of video, audio or other data signals and the like, which may be in any of many different formats. The source information may originate as fixed- or variable-size frames, packets or cells, such as Internet protocol (IP) packets, Ethernet frames, Asynchronous Transfer Mode (ATM) cells, etc., as provided to the distribution hubs 105. Any such type of digital information in fixed- or variable-sized frames, packets or cells is referred to herein as “packetized” data. The packetized data includes one or more destination addresses or the like indicating any one or more specific subscriber devices at the subscriber locations 109. The CPE at each subscriber location 109 includes the appropriate communication equipment to receive and demodulate received information, and decode address information to deliver the original content intended for the subscriber. Upstream subscriber information may be handled in a similar manner, and will not be further described herein.

It is noted that many different modulating frequencies and techniques are contemplated for both downstream and upstream communications. Modulation techniques may include, for example, Frequency Shift Keying (FSK), Quadrature Phase-Shift Keying (QPSK), as well various types of Quadrature Amplitude Modulation (QAM), such as QAM 16, QAM 64, QAM 256, etc., among other modulation techniques. Also, each frequency or “physical” channel may have any predetermined bandwidth, such as 1 MHz, 3 MHz, 6 MHz, 12 MHz, etc. Each channel typically includes a separate downstream and upstream channel separated in frequency, where the corresponding down and upstream channels may have the same or different channel width. Further, the modulation technique employed for each downstream channel may be the same or different than the modulation technique employed for each upstream channel.

In one embodiment, the communication system 100 is an HFC system that supports analog television broadcast transmission in which broadcast television channels are allocated to a particular frequency range of the overall available RF cable television spectrum (5 MHz-1 GHz). The remaining portion of the RF cable television spectrum is utilized to assign data channels including any combination of downstream and upstream channels. For example, some HFC systems implement an extended sub-split frequency plan with a return band, which extends from 5 to 42 MHz, and a forward band, which extends from 52 to 750-860 MHz. It is understood that the particular frequency ranges described herein are exemplary only and that any frequency allocation scheme may be employed depending upon the desired configuration.

In one exemplary embodiment, the entire forward band is segmented into 6 MHz channels according to the channelization plan implemented by the particular HFC network operator. For typical HFC plants supporting analog television broadcasts, 80 analog channels are transmitted in the forward band between 53 and 550 MHz. In such HFC networks, satellite signals and local analog stations are mapped to 6 MHz broadcast channels within the forward band at the headend 103. Each 6 MHz forward band channel may contain an analog channel or multiple digital channels that are MPEG encoded (Moving Picture Experts Group, e.g. MPEG-2). Each 6 MHz channel is upconverted to a frequency within the forward band according to the appropriate channelization plan. The return band (5-42 MHz) of the extended sub-split frequency plan and the remaining forward band spectrum, including frequency ranges 550 to 750-860 MHz, is allocated to subscriber digital channels and/or data transmission for dedicated bandwidth to each subscriber location 109. For example, the frequency range 550 to 860 MHz is allocated for downstream channels and the frequency range 5 to 42 MHz is allocated for upstream channels.

In alternative embodiments of the communication system 100, such as an all-digital HFC system, a substantial portion or the entire available spectrum is utilized to assign channels to each of the subscribers. In an all-digital HFC network, for example, there is no requirement for broadcast transmission of analog channels over the same frequencies used to transmit broadcast channels using off-air frequencies (i.e. Channel 2 at 54 MHz in the HRC frequency plan). As a result, the filter frequency settings on the diplexer in an all-digital network may allow increased spectrum allocation for upstream communications. For instance, mid-split and high-split frequency plans, which are suitable for an all-digital network, allocate the 5-86 MHz and 5-186 MHz ranges, respectively, for upstream transmission. Consequently, all-digital networks allow more upstream bandwidth for interactive services such as data over cable services. In these all-digital embodiments, the relatively large bandwidth otherwise consumed by television broadcast information is available for channel assignments. A different frequency spectrum split may be utilized to increase upstream bandwidth availability, and enables a symmetrical configuration with equal downstream and upstream bandwidth. Embodiments with a smaller geographic serving area provide a reduced noise node so that each subscriber location 109 receives a cleaner signal, typically without the need for amplification.

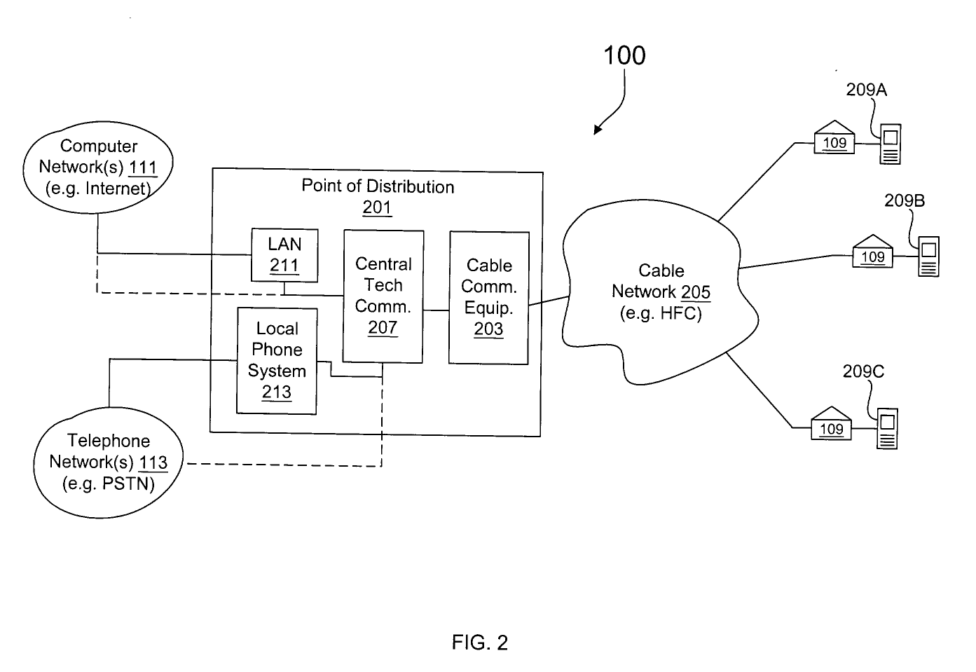

FIG. 2 is a simplified view of the communication system 100 illustrating interface of a central technician communicator 207 (“central communicator 207”) and multiple field technician communicators 209 (“tech communicators 209”), individually shown as 209a, 209b, 209c, etc., each configured according to embodiments of the present invention. In general, the central communicator 207 enables the tech communicators 209 to communicate via the communication system 100 with each other and with external devices via external connections, described further below. The central communicator 207 is located at a convenient point of distribution 201, which may be the headend 103 or any of the distribution hubs 105, and couples to the cable communication equipment 203 located at the point of distribution 201. An intermediate cable network 205 represents the cable or HFC infrastructure linking the point of distribution 201 with the subscriber locations 109 via the cable communication equipment 203. The tech communicators 209 are configured to connect to coaxial cables routed to each of the subscriber locations 109. The central communicator 207 is configured to establish a communication link with other tech communicators 209 “on network” or connected to the cable network 205, and may further be configured as a gateway to enable “off-network” or communications with voice and/or data networks external to the cable network 205. As shown, for example, the central communicator 207 includes a communication interface for coupling to a local area network (LAN) 211 or the like, for enabling data communications between any tech communicator 209 and data devices or services at the point of distribution 201.

The central communicator 207 may further be coupled to external data or computer networks, such as the computer networks 111, either directly or via the LAN 211. In a similar manner, the central communicator 207 includes one or more communication interfaces for coupling to a local phone system 213 or the like. The phone system 213 enables voice communications with local personnel, such as other technicians, supervisors, dispatch personnel, etc. The central communicator 207 may further be coupled to external voice or date networks, such as the telephone networks 113, either directly or via the local phone system 213. For example, the central communicator 207 may be connected to a private branch exchange (PBX) system or the like for enabling local and external phone communications.

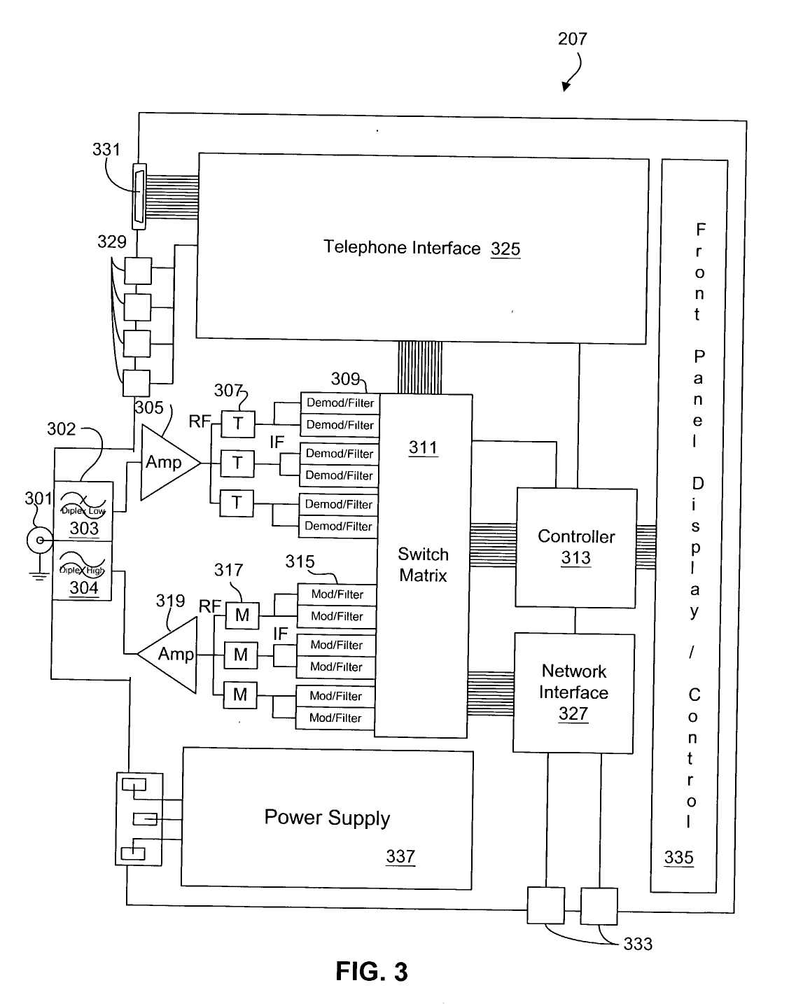

FIG. 3 is a block diagram of an exemplary embodiment of the central communicator 207. The central communicator 207 includes an RF input cable connector 301, which interfaces the cable communication equipment 203. The cable connectors 301 may be, for example, a standard 75 ohm coaxial cable two-wire F-connector, which is standard in the cable industry. The connector 301 is coupled to a diplex filter 302, which includes a low pass filter 303 and a high pass filter 304. Upstream signals are provided to the input of a pre-amplifier 305, which asserts its output to one or more tuners 307. Each tuner 307 is configured to tune to any one of multiple consecutive upstream frequency channels. In one embodiment, each tuner 307 tunes to any selected 5 MHz channel within a frequency range of 5 to 65 MHz. Although the channels in this embodiment are 5 MHz wide, they may be centered on 6 MHz cable channels for compatibility with the underlying cable architecture and to provide sufficient guard bands on either side of the channel. For example, the channel center frequencies may be positioned at 9, 15, 21, 27, etc. MHz, so that the 5 MHz channels are located at 6.5-11.5 MHz, 12.5-17.5 MHz, 18.5-23.5 MHz, 24.5-29.5 MHz, etc. It is noted that only the frequency range of 5-40 MHz is used for upstream communications if the communication system 100 is configured according to the extended sub-split frequency plan. The higher frequency upstream channels between 40-65 MHz are used for those frequency plans having a wider upstream frequency bandwidth. The number of tuners 307 is arbitrary and is selected to enable simultaneous communications using as many channels as desired.

Each tuner 307 includes one or more mixer stages in which one or more carrier signals are combined with the received RF signal of the selected channel to provide an intermediate frequency (IF) modulated signal. The carrier signals employed correspond with the center frequencies of the selected channel configuration. The amplifier 305 is provided to maintain performance specifications. The IF output of each tuner 307 is provided one or more demodulator and filter circuits 309, each configured for a particular discrete baseband channel. Splitters (not shown) may be used to provide a separate IF signal to the input of each demodulator and filter circuit 309. It is noted that each RF channel may further be sub-divided into a predetermined number of separate baseband channels, so that a separate demodulator and filter circuit 309 is provided for each sub-channel. Although two demodulator and filter circuits 309 are shown for each channel, it is understood that any suitable number may be included. Sub-channels are implemented depending upon the selected modulation scheme employed. For Code Division Multiple Access (CDMA), for example, each demodulator and filter circuit 309 uses a separate code to distinguish a sub-channel within the primary channel. Each demodulator and filter circuit 309 demodulates the IF signal into a discrete baseband signal, which is input to a cross-connect switch matrix 311. The baseband signals are forwarded under control by a controller 313 coupled to the switch matrix 311.

Output baseband channel signals directed towards the cable network 205 are routed to modulator and filter circuits 315, each of which modulates a corresponding baseband signal into a corresponding IF signal. One or more IF signals are provided to a corresponding one of multiple RF modulators 317, each converting one or more IF signals into a selected RF channel within the appropriate frequency range (e.g. 550-860 MHz). A combiner circuit (not shown) may be employed to combine multiple IF signals into a combined signal to the input of each RF modulator 317. Multiple IF signals may be combined as sub-channels into a single RF channel. Each RF modulator 317 outputs an RF signal on a selected channel to the RF connector 301 via the high pass filter 321 of the diplex filter 302 for downstream communications via the cable network 205. In one embodiment, each RF modulator 317 is capable of tuning to any channel within the entire operating range, such as 5-860 MHz. Alternatively, each RF modulator 317 is capable of tuning to all or a selected portion of the pre-defined downstream frequency range, such as 50-860 MHz. One or more output gain stage amplifiers 319 are provided if necessary to maintain performance specifications.

The switch matrix 311 is coupled via separate data paths to a telephone interface 325, the controller 313 and a network interface 327. The telephone interface 325 may include the necessary conversion functionality to convert the baseband signals to telephonic data. In a similar manner, the network interface 327 may include the necessary conversion functionality to convert the baseband signals to network communications.

The telephone interface 325 is coupled to one or more input/output (I/O) telephone ports 329, such as standard modular telephone RJ-11 jacks or the like, for interfacing the local phone system 213 and/or the telephone networks 113. The telephone interface 325 includes a serial interface 331 for connecting to a management console (not shown) for purposes of configuring and managing the central communicator 207. The management console may be implemented on a computer, such as a PC or laptop or the like. The network interface 327 is coupled to one or more I/O network ports 333, such as standard modular RJ-45 jacks or the like, for interfacing the LAN 211 and/or the computer networks 111. Any suitable type of network architecture is contemplated for the network interface 327, such as according to various Ethernet standards (e.g., 100 Base-T). In this manner, the switch matrix 311 is capable of routing (or forwarding) communications between the tech communicators 209 via the cable network 205, telephonic phone systems or networks 213, 113 via the telephone interface 323, and any selected network 211, 111 via the network interface 327. Any channel or baseband signal may also be routed to the controller 313, such as control, status or administrative signals or any new channel communications in which a signal path is to be resolved.

The controller 313 is coupled via control signal lines to the telephone interface 325, the switch matrix 311, the network interface 327 and a front panel system (display and control) 335. The front panel system 335 includes a display for displaying active channels and has suitable controls to enable a technician or administrator to coordinate channel routing and set up frequency selection. The front panel system 335 may also include health and power status lights or the like. In one embodiment, the central communicator 207 is built into a one rack mountable unit (not shown) as known to those skilled in the art, including an internal 110 Volt AC power supply 337.

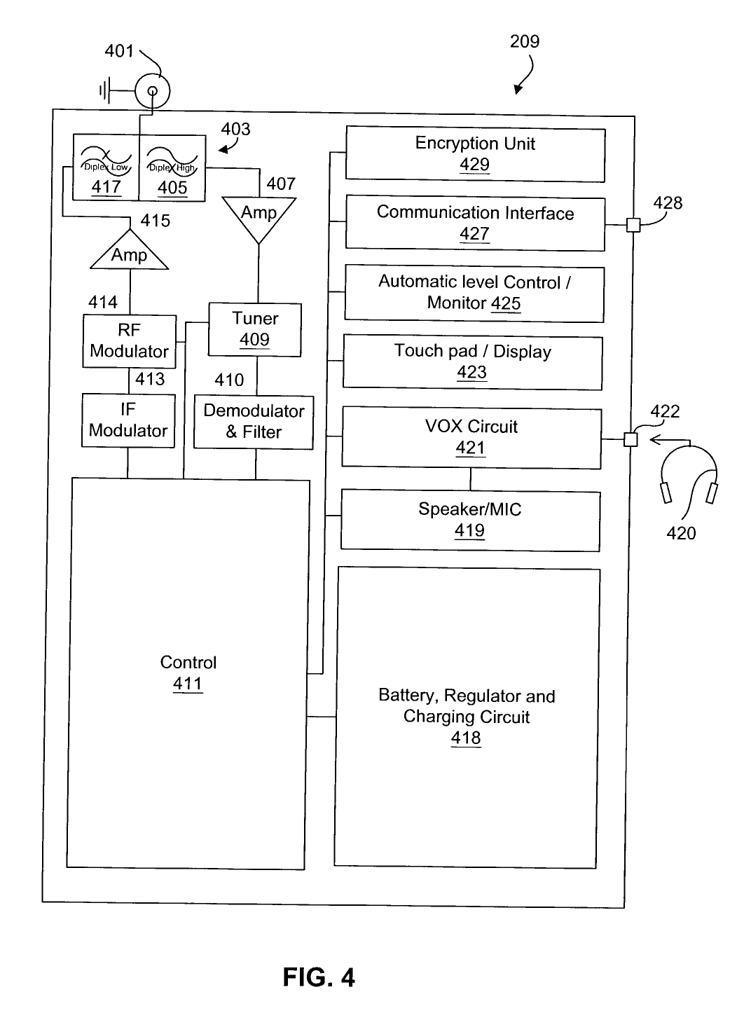

FIG. 4 is a block diagram of an exemplary embodiment of a tech communicator 209. In one embodiment, the tech communicator 209 is built into a handheld sized, battery-powered device that may conveniently be clipped to a field technician's belt. The tech communicator 209 may be configured in any convenient manner, such as including a touch pad and liquid-crystal display (LCD) or the like. In a specific configuration, the LCD is located on a front panel and includes at least 4 lines by 32 characters to enable the field technician to coordinate channel routing, set up frequency selection, and control any other peripheral interfaces. It also may have status indicators, such as health and power status lights or the like. Many peripheral interface options are contemplated, such as a Universal Serial Bus (USB), a serial port, an infrared port, etc., and multiple interfaces may be employed. Such peripheral interface options are contemplated for data transfer options, as described further below.

The tech communicator 209 includes a single RF connector 401 for connecting to a coaxial cable of the cable network 205. Such connection may be made anywhere in the cable network 205, such as at any subscriber location 109. The connector 401 may be a standard 75 ohm coaxial cable two-wire F-connector in a similar manner as the connector 301. The connector 401 is coupled to a diplex filter 403, which includes a high pass filter 405 that forwards received RF signals to a tuner 409 via a gain stage amplifier 407. The tuner 409 operates in similar manner as any of the tuners 307, except that the tuner 409 is configured to tune to any selected downstream channel or to any one of a predetermined number of downstream channels. The tuner 409 provides an IF signal to a demodulator and filter circuit 410, which converts the IF signal into a baseband signal. The baseband signal is provided to a control block 411, which processes baseband signals. The control block 411 provides an upstream baseband signal to an IF modulator 413, which provides a corresponding IF signal to an RF modulator 414. The RF modulator combines a selected upstream RF carrier signal with the IF signal for the frequency range of a selected upstream channel. The upstream RF channel signal is provided to the connector 401 via a gain stage amplifier 415 and a low pass filter 417 of the diplex filter 403. The channel frequencies and bandwidths employed by the tuner 409 and RF modulator 414 are compatible with the selected frequency plan. The control block 411 is shown coupled to the tuner 409 and RF modulator 414 for selecting the appropriate downstream and upstream channels.

It is noted that the tech communicator 209 is shown in generic form and that many different configurations are possible and contemplated. In one embodiment, the control block 411, the IF modulator 413 and the demodulator and filter 410 are implemented using a cellular PCS (Personal Communications Services) chipset typically used to enable wireless digital cellular transmissions for wireless cell phones using PCS spread spectrum communications. Even though not used for “wireless” communications in this configuration, cellular PCS chipsets provide a convenient off-the-shelf approach to enabling communications via the cable network 205. The present invention, however, is not limited to any particular communication method or chipset.

The control block 411 is also coupled to various other functional blocks within the tech communicator 209 for establishing desired functionality. The control block 411 is shown coupled to a battery, regulator and charging circuit 418 including a rechargeable battery (e.g., NiCd, NiMH, etc.) for providing power to the tech communicator 209 either via the battery or an AC charging adapter. The control block 411 is coupled to a speaker/MIC interface 419 for establishing voice/audio communications employing a local speaker and microphone (not shown) integrated on the chassis of the tech communicator 209 in a similar manner as a standard telephone. A VOX circuit 421 is coupled to the control block 411 and the speaker/MIC interface 419 for enabling a headset option. A headset 420 is plugged into a connector or receptacle 422 to enable voice communications with the headset, which optionally overrides the speaker/MIC interface 419. A touch pad and display interface 423 is coupled to the control block 411 for receiving touch pad commands and for displaying information via the LCD or the like on a front panel of the unit. An automatic level control and monitor circuit 425 is coupled to the modulation and control block 411 for power ranging to control signal levels of received and transmitted signals for voice and data communications. The control block 411 is coupled to a peripheral interface 427, which incorporates one or more of several types of peripheral ports or interfaces, such as USB, serial, infrared, etc. An auxiliary connector 428 is illustrated for connecting to one or more external devices. An optional encryption block 429 is provided and coupled to the modulation and control block 411 for encrypting outgoing voice or data information and for decrypting or otherwise decoding incoming communications when activated.

The type and number of auxiliary connectors 428 depend on the type of peripheral interface implemented. A USB and/or serial port and/or infrared port enables communication with other devices that may be used by the field technician, such as a barcode reader, a laptop, a pocket-PC, a personal digital assistant (PDA), a meter or other measuring equipment, etc. The pocket-PC may be equipped to attach a bar-code reader, which is read by the tech communicator 209 via the selected communication interface 427. A bar code reader option enables the field technician to scan bar codes of subscriber equipment, such as set top boxes, cable modems, etc. The bar code may incorporate information about the scanned device, such as make, model, version, type, specifications, etc. Such information may facilitate troubleshooting subscriber equipment or network-related problems, and further may facilitate updating subscriber information in a central database.

The illustrated tech communicator 209 is suitable for full-duplex communications through the central communicator 207. The tech communicator 209 shown may be modified to enable direct tech communicator field unit-to-unit full-duplex communications as long as the tech communicators are physically located along the same coaxial cable link, such as any one of the links 108. For direct unit-to-unit communications, each tech communicator 209 is configured to receive an upstream channel and transmit via a downstream channel. Thus, each tech communicator 209 includes an additional upstream tuner and a downstream RF modulator. The control block 411 is configured to receive or detect a direct communication command, such as a button on the unit or a code number dialed on its keypad, to enable the alternative direct communication mode. Also, the central communicator 207 may be involved to facilitate direct communications. For example, once a communication link is established between two tech communicators 209 via the central communicator 207, the two field units may be released for direct communications. The field technician typically carries equipment for making measurements or for collecting other types of information in the field. The tech communicator 209 may be used to retrieve and locally store data and information from other devices, such as equipment, bar code readers, pocket PCs, etc., via one or more peripheral interfaces. If used to store information, the tech communicator 209 includes memory (not shown) for storing information that may be later retrieved by another device, such as a computer located at the point of distribution 201 (e.g. headend). Alternatively, the tech communicator 209 serves as a communication gateway for coupling to various types of field equipment and for transferring data directly to a device at a remote location, such as a computer at the point of distribution 201. The field technician may also be required to fill out trouble ticket reports or the like including a description of work performed and/or completed and any additional information collected in the field. Upon completion of a job, the field technician may be able to remotely close out the ticket while located in the field using the tech communicator 209. The tech communicator 209 may be employed at the subscriber location 109 to update subscriber records (e.g. billing records) and information maintained at the point of distribution 201 or other cable operator office.

Many different modulation techniques are contemplated for enabling field technician communications between the tech communicators 209 and one or more central communicators 207 across the cable network 205, such as FSK, QPSK, QAM, Spread Spectrum, etc. Although cost may be reduced using simpler modulation techniques, more sophisticated modulation techniques provide greater immunity to noise and interference and enable greater rates for data communications. As described previously, the cable network 205 is established according to a predetermined frequency plan with predefined channel spacing. Several plans exist for different geographic markets (e.g., United States, Asia, Europe, Australia, etc.). In the United States, for example, several plans are known such as an extended sub-split frequency plan in which the diplex filter separating the downstream from the upstream is located within the frequency range of approximately 42 to 54 MHz. The extended sub-split frequency plan includes multiple downstream channels in the 55-860 MHz frequency range and upstream channels in the 5-40 MHz frequency range. Analog television may occupy the downstream spectrum between 54 MHz to 550 MHz, and cable modem communications may reside in a portion of the remaining spectrum from 550 to 860 MHz. Each channel may be 1 MHz, 3 MHz, 6 MHz, 12 MHz, etc., although 6 MHz is typical.

The field technician communications are configured to avoid interference with the established cable communications. In one embodiment, field technician communications are configured to be compatible with the established cable communications, such as capable of receiving and decoding MPEG-2 frames or the like. Alternatively, field technician communications may be according to any selected modulation technique regardless of the established cable communications, as long as the communications are contained within unused channels or frequency ranges and otherwise do not cause interference. As described previously, for example, field technician communications may use 5 MHz channels centered within 6 MHz cable channels providing a suitably wide guard band within the cable channel.

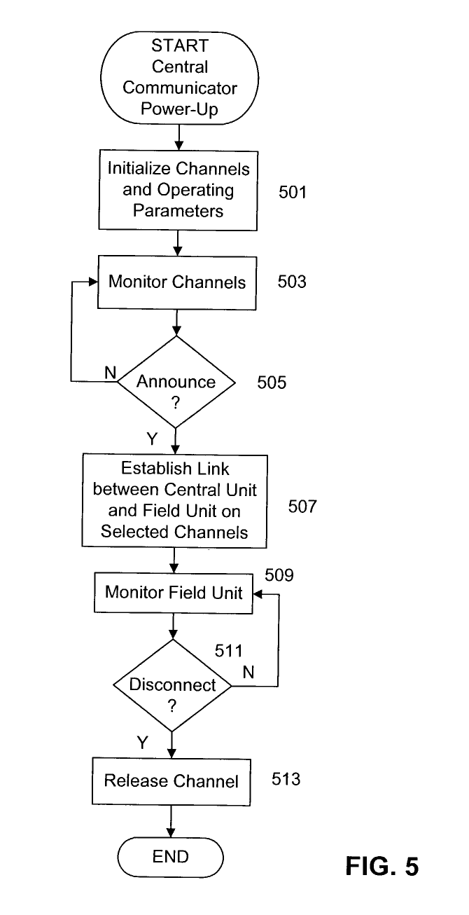

FIG. 5 is a simplified flowchart diagram illustrating operation of the central communicator 207 according to an embodiment of the present invention for establishing communication links with each of the tech communicators 209 upon power up of the central communicator 207 and the control block 313. It is noted that this and the following flowcharts only illustrate primary operating functions, and that many specific details are not included as being subject many possible variations and engineering choices. At a first block 501, the control block 313 initializes the downstream and upstream communication channels and any operating parameters. A tech communicator database is contemplated that lists tech communicators 209 by unit number that are pre-authorized for communication with the particular central communicator unit. Alternatively, each tech communicator 209 provides its unit number when establishing communications, where the control block 209 keeps track of each unit and its operating status. Security may be handled by a user number or password, as further described below.

Many options are contemplated for the particular channels employed for field technician communications. In one embodiment, the particular upstream and downstream channels used are fixed or otherwise predetermined for a particular cable network 205. Such predetermined channel configuration is stored and consulted upon power up. Alternatively, the channels used may vary over time or for particular configurations. For variable channel formats, the central communicator 207 may be configured to periodically scan all or a selected portion of potentially available channels and select those channels that are available or otherwise not in use. In one embodiment, each central communicator 207 uses a control channel to identify when and where each tech communicator 209 receiver is activated and attached to the cable network 205. The control channel may be used as a broadcast channel by the central communicator 207 to send communication and administrative details and information. Such broadcast information may include, for example, particular modulation scheme(s) being used and the available channels for field technician communications. Such downstream information may further include the identity of an upstream channel that may be used by each tech communicator 209 to announce to the central communicator 207 that the unit is attached and activated.

Operation proceeds to next block 503 in which the control block 313 monitors one or more upstream channels for Announce Indications as represented by next decision block 505. A loop may be employed in which the control block 313 continuously scans one or more upstream channels for Announce indications. In one configuration, the control block 313 transmits channel information in the downstream control channel that identifies an upstream channel to be used by a new tech communicator 209 for announcing its presence on the cable network 205. The channel information may include, for example, the identity of a particular sub-channel within an upstream RF channel. In a CDMA configuration, for example, the sub-channel may be identified by an RF channel and a code to be used by a new tech communicator 209 attempting to initiate communications. The new tech communicator 209 retrieves the channel information from the control channel, tunes to the identified upstream channel, and transmits its Announce indication. The central communicator 207 may define one or more upstream channel dedicated for field unit announce indications. Multiple announce channels reduce potential conflict between two or more units attempting to establish a link at the same time. After a new field unit is detected, it is programmed with a new “permanent” upstream channel for its subsequent communications. If several dedicated announce channels are defined, the central communicator 207 switches to a different upstream announce channel for the next new unit to announce its presence after a new field unit transmits an announce indication. The central communicator 207 may alternate between two or more announce channels in this manner.

In yet another embodiment, the central communicator 207 simply identifies the next available upstream channel during downstream broadcast communications on the selected control channel. Each new field unit detects the upstream channel information, tunes to that channel and transmits its announce indication. Upon detecting an announce indication from a new field unit, the central communicator 207 establishes that upstream channel for normal communications by the new unit and switches the announce channel to the next available channel for use by the next new field unit.

The central communicator 207 detects an announce indication on a channel at block 505, and proceeds to next block 507 to establish a communication link with the new tech communicator 209 on selected downstream and upstream channels. In one embodiment, the control block 313 transmits an acknowledge indication to the new tech communicator 209 on the downstream control channel. The Announce Indication may contain little or no information and may simply be a “dumb” indication. Alternatively, the new field unit may program its unit number or any other identification (ID) information into the Announce Indication, such as its destination address or the like. The control block 313 receives the ID information and uses it to transmit communications directly to the new field unit, such as using a corresponding destination address. The acknowledge transmission from the central communicator 207 may include new channel programming information, such as new downstream and/or upstream channels for “permanent” use by the field communicator 209. If the downstream channel is a dedicated control channel, then the control block 313 may program a new downstream channel to keep the control channel free. If the upstream channel is a dedicated announce channel, then the control block 313 may program a new upstream channel to keep the announce channels free.

As described above, the central communicator 207 may consult a pre-programmed database of authorized tech communicators 209. If the central communicator 207 does not recognize the destination address or unit identifier (such as via a predetermined user lookup table), it may terminate the upstream communications or otherwise ignore the attempted Announce Indication. Additional security is contemplated. The Announce Indication may be programmed with a user credential information (e.g., username and/or password) that is examined and compared by the control block 313 with the authorized database. Each tech communicator 209, upon power-up, may be configured to request the credential information from the current user, where the credential information received from the user is then incorporated into the Announce Indication. For example, the LCD may display “Password?” or the like prompting the field technician to enter a password on the keypad of the tech communicator 209, which data is transmitted to and decoded by the control block 313. Alternatively, the acknowledge sent by the central communicator 207 may be (or otherwise include) a request for the credential information, which causes the tech communicator 209 to prompt the technician for the information. Alternatively, the central communicator 207 may request user credentials after the tech communicator 209 is programmed with its permanent channel to avoid tying up control channels. If the credential information is not recognized or is incorrect, further communications are disabled.

After a communication link is established between the central communicator 207 and a tech communicator 209, operation proceeds to block 509 at which the control block 313 monitors the communication status of the new tech communicator 209. As indicated at next decision block 511, the control block 313 monitors the selected communication channels to determine if and when the tech communicator 209 is disconnected or otherwise powered off. When the tech communicator 209 is detected disconnected or otherwise powered off at block 511, operation proceeds to next block 513 in which the channel is released by the control block 313.

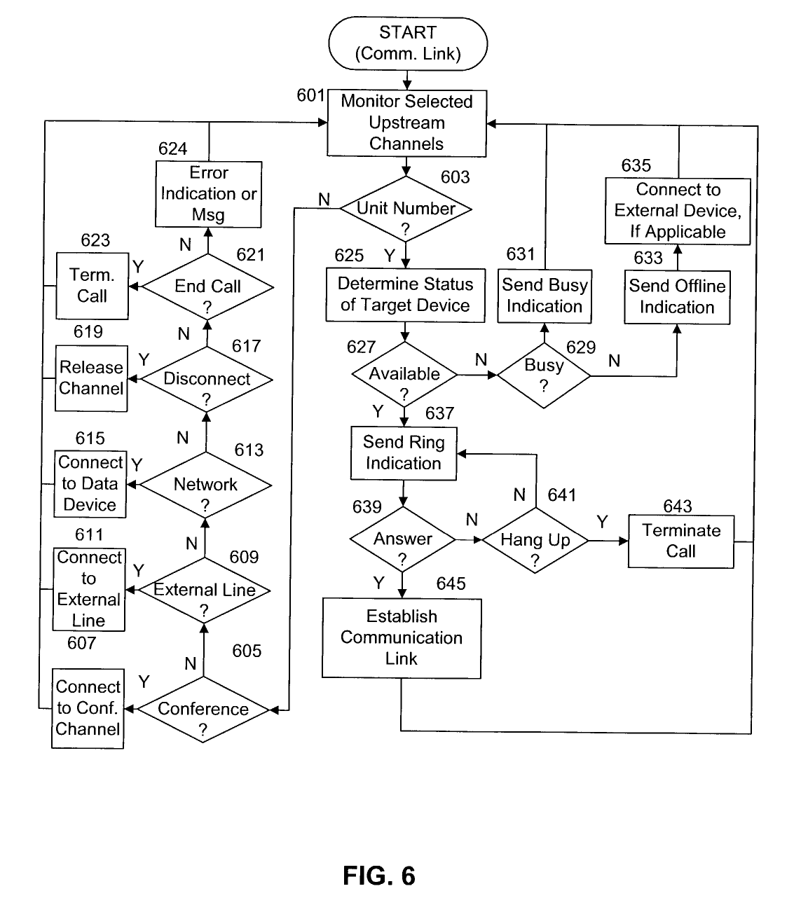

FIG. 6 is a simplified flowchart diagram of operation of the control block 313 of the central communicator 207 for establishing communication connections between the tech communicators 209 and with other devices. The establishment of communication link with the central communicator 207, previously described, is performed to log the tech communicator 209 into the system so that the central communicator 207 may establish voice and/or data connections with other field units or other devices. The upstream communications from each of the linked field units are initially routed to the control block 313 for purposes of interpreting information received and for establishing communication connections. Each tech communicator 209 has an identifier, such as a unit number or the like, which may also operate in a similar manner as a “phone number” for purposes of enabling private calls between two tech communicators 209. The user of a linked tech communicator 209 presses buttons or otherwise enters numbers on its keypad with the intent on establishing communications with one or more devices. In one embodiment, the tech communicator 209 transmits a Dual-Tone Multi-Frequency (DTMF) for each digit entered to the central communicator 207 via the upstream channel.

At block 601, the control block 313 monitors the upstream channels to retrieve information from linked tech communicators 209. The control block 313 examines the information received from a tech communicator to determine if it corresponds to a known unit number (block 603), a channel dedicated to conference calls (block 605), an outside or external phone line (block 609), an external network or data line (block 613) a disconnect signal (block 617), or an End Call indication (block 621). It is noted that many other indicators or information is contemplated and that the specific examples are for purposes of illustration and not intended to be exhaustive. In many situations, as described further below, the control block 313 programs the switch matrix 311 to forward communications between field units and other devices. Certain control indicators or administrative packets or the like are still forwarded to the control block 313 so that it ultimately retains control of the field communication channels.

A conference call number or indicator detected at block 605 causes the control block 313 to program the switch matrix 311 to connect the tech communicator 209 with a predetermined downstream conference channel as shown at block 607. The conference channel may be accessed in a similar manner as a private call, such as by entering a conference number or the like, and the central communicator 207 adds the tech communicator 209 to the conference channel. Each field unit connected to the conference channel hears all other units so connected so that three or more field technicians may communicate with each other. A conference channel enables multiple technicians to access a common line. The control block 313 may further be configured to enable 3-way calls by allowing one tech communicator 209 to call multiple other tech communicators 209 or external telephones and link them together into a common communication channel.

An indication to connect to an external telephone line at block 609 causes the control block 313 to program the switch matrix 311 to connect the tech communicator 209 with a specific telephone device or with an outside telephone line via the telephone interface 325 as shown at block 611. The specific details of the operation of the telephone interface 325 are not described as being beyond the scope of this disclosure. As an example, a first dialed number “9” establishes an outside line via the telephone network 113 so that a dial tone or the like is returned to the tech communicator 209. The user may then enter a phone number in standard format as though using a standard telephone in which DTMF tones are used for dialing. The control block 313 may be configured to automatically determine the format of a number entered as an external phone line and to automatically establish the connection to enable an external phone call. For example, in the U.S., an initial number “1” followed by an area code and seven digit phone number, or entry of a standard seven digit local number may automatically cause the control block 313 to forward the call to the telephone interface 325 for establishing a long distance or local phone call, respectively.

An indication to connect to an external data or network device at block 613 causes the control block 313 to program the switch matrix 311 to connect the tech communicator 209 with a specific network device or with an external network via the network interface 327 as shown at block 615. The specific details of the operation of the network interface 327 are not described as being beyond the scope of this disclosure. A user may access a predetermined data channel or use a channel for data communications. The user may enter a predetermined digit to reach a data line or indicate a data communication call. The user then enters a phone number or the like to access a computer or other data communication device, such as a computer located in the LAN 211, in a similar manner as a dialup modem. It is noted, however, that each data channel or data communications via the cable network 205 may have a substantially greater bandwidth and data capacity as compared to a standard dialup modem. For example, a data channel used for the tech communicator 209 may have a raw data throughput of up to 20 Mbps or more depending upon channel bandwidth and modulation techniques employed. Many protocols are possible for establishing data communications between a device coupled to an auxiliary port 428 and a device coupled via the network interface 327. In one embodiment, a standard hardware protocol is employed including the signals Data Terminal Equipment Ready (DTE), Clear To Send (CTS), Request To Send (RTS), Data Communications Equipment Ready (DCE), etc.

The control block 313 detects a disconnect indication at block 617 in which a tech communicator 209 powers down or disconnects from the cable connection thereby disconnecting from its communication link with the central communicator 207. If so, the control block releases the linked channel as shown at block 619 and removes the associated field unit from the list of linked devices. Once a communication connection is established, the control block 313 detects an End Call indicator at block 621 and terminates the call as shown at block 623. An End Call indicator may be transmitted, for example, when either of the units or devices communicating hangs up or otherwise terminates the call. The control block 313 may terminate the call by reprogramming the switch matrix 311 to route further communications of a tech communicator 209 back to the control block 313 to resume linked status. Of course, if the tech communicator 209 disconnects from its linked channel, the control block 313 releases the channel (e.g., block 619).

Additional options may be employed but are not further discussed herein. If the number or identifier entered by a user technician is not recognized as a valid indication or number, then an error indication or message is generated as indicated at block 624. For example, an error message may be transmitted to the source tech communicator 209 indicating an erroneous number. An error indication may also be deployed by the control block 313 to be displayed by the front panel system 335 for informing an operator or administrator if desired. From any of the blocks 607, 611, 615, 619 or 624, operation proceeds back to block 601 for continued channel monitoring.

The central block 313 detects an inquiring unit attempting to contact another field unit at block 603, such as by a unit number or the like, indicating a unit to unit call. If so, operation proceeds to block 625 at which the control block 313 determines the status of the indicated target tech communicator 209. The control block 313 determines whether the target unit is available at decision block 627, and if not, determines whether the target unit is busy at next decision block 629. If the target unit has an established communication link (e.g., is connected and powered on or otherwise on standby mode) but is busy communicating with another unit or device as determined at block 629, then the control block 313 sends a busy indication to the inquiring unit at next block 631. Such busy indication may be a predetermine busy signal or the like that is provided to the inquiring unit in the form of an audible (speaker sound or beep) or visual indication (status LED or the like). After the busy indication is transmitted, operation proceeds back to block 601 for continued channel monitoring. Optionally, the attempted call may be terminated by the control block 313, such as on timeout or upon detection of hang-up of the inquiring unit. However, the control block 313 may also detect a hang-up indication at block 621 (being the same or similar to an End Call indication), in which the call is terminated at block 623.

If the target unit is known but has not previously established a communication link with the central communicator 207, then the target unit is considered “offline”. At next block 633, an optional offline indication may be transmitted to the inquiring unit. In addition or in the alternative, operation proceeds to block 635 in which the inquiring unit is automatically forwarded or connected to a different device associated with the target unit number. For example, instead of dropping or terminating the call, the control block 313 optionally forwards the call to a voicemail system or to an external phone line in the local phone system 213 corresponding to a technician associated with the target tech communicator 209. Operation proceeds back to block 601 for continued channel monitoring.

If the target tech communicator 209 is available as determined at block 627, operation proceeds to next block 637 at which a ring indication is sent to the target unit, such as a buzzer or ringer signal or the like. At next decision block 639, the control block 313 determines whether the user of the target tech communicator 209 answers. If not, the control block 313 monitors the inquiring unit to determine whether a hang-up indication or the like is sent at next block 641. The control block 313 loops between blocks 637, 639 and 641 until an answer indication is received from the target unit or a hang-up indication is received from the inquiring unit or if an optional timeout period has expired. Upon hang-up or timeout, operation proceeds to block 643 to terminate the call and then back to block 601 for channel monitoring. If the user of the target unit answers as indicated at block 639, then the control block 313 establishes a communication connection between the two tech communicators 209 as indicated at block 645. Operation returns back to block 601 for continued channel monitoring.

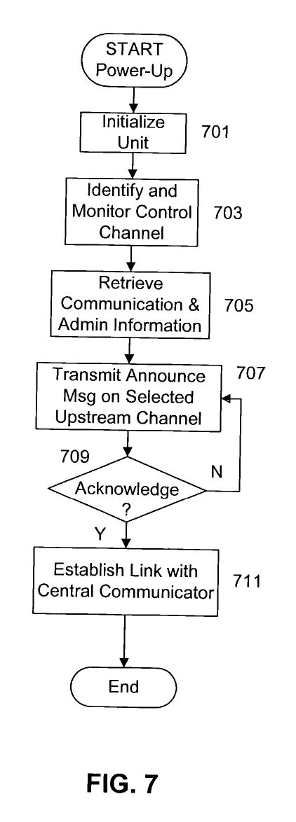

FIG. 7 is a flowchart diagram illustrating power up and initial operation of the tech communicator 209 for establishing a communication link with the central communicator 207. The field unit is initialized at first block 701 during power up. At next block 703, the unit identifies and monitors the downstream control channel. The downstream control channel may be fixed or otherwise predetermined, so that each tech communicator 209, after being attached and activated, tunes to the predetermined control channel to receive information from the central communicator 207. Alternatively, the tech communicators 209 are configured to scan the available downstream channels to search and identify the control channel, such as scanning each of the downstream channels from top to bottom until the downstream control channel being used by the central communicator 207 is located. In the scan embodiment, the tech communicator 209 tunes to the center frequency of each channel and attempts to resolve downstream communications. If communications do not exist, are not recognized or are otherwise not identifies as being from the central communicator 207, the next channel is examined.

At next block 705, after the control channel is identified, the tech communicator 209 retrieves communication and administrative information from the control channel and identifies an indicated or selected upstream channel for communicating with the central communicator 207. At next block 707, the tech communicator 209 transmits its Announce Indication on the selected upstream channel as previously described. The Announce Indication may be a static value, but may also include a destination address or unit identifier and may further include user credentials. The destination address or unit identifier enables the central communicator 207 to recognize the particular unit or to at least log the unit into its local database. In one security embodiment, the tech communicator 209 powers up and requests the user credentials from the technician, which information is transmitted to the central communicator 207 via the Announce Indication. The control block 313 receives and decodes the Announce Indication and attempts to identify the tech communicator 209 or otherwise log the unit in its database.

The central communicator 207 transmits an acknowledge signal or notification to the tech communicator 209 to initiate two-way communications. At next block 709, the tech communicator 209 queries whether the acknowledge is received. If the acknowledge is not received, the tech communicator 209 waits for an arbitrary, predetermined or randomly determined amount of time and either displays an error indication on its display to the user, or transmits another Announce Indication. If and when the acknowledge is received, operation proceeds to next block 711 in which the tech communicator 209 establishes a communication link with the central communicator 207. The central communicator may reprogram or send new channel information to the tech communicator 209 to change its downstream and/or upstream channels to “permanent” settings (at least for the current session). If the control channel is dedicated for control information only or otherwise approaching full capacity, the control block 313 may allocate a new downstream channel for the tech communicator 209. If the upstream channel is a dedicated Announce channel, then the control block 313 allocates a new upstream channel as well.

Once a communication link is established with the central communicator 207, the user of the tech communicator 209 may attempt to connect to another unit or device or channel as previously described. The user may access other tech communicators or external devices via the telephone or network interfaces or a conference channel if established. Many other options are possible and contemplated. The tech communicator 209 may also be used for limited line testing. Diagnostic signals may be transmitted downstream by the central communicator 207 for reception by the remotely located tech communicator 209. The tech communicator 209 may be used to determine if the signals are received and may sense carrier signals to determine the status of the cable line.

Although various embodiments of the present invention have been described in detail, it should be understood that various changes, substitutions and alterations can be made hereto without departing from the spirit and scope of the invention as described by the appended claims.

1. A communication system for field technicians of a cable network, comprising:
at least one portable technician communicator, each configured to couple to a coaxial cable connector of the cable network, and each capable of enabling full duplex communications using selected upstream and downstream channels of the cable network; and
a central communicator, for coupling to the cable network at a point of distribution, comprising:
a plurality of transceivers, each for establishing a communication link with any technician communicator that is connected to the cable network;
a switch matrix, coupled to the plurality of transceivers, that forwards upstream and downstream communications between linked technician communicators; and
a controller, coupled to the switch matrix, that detects requests by technician communicators to establish a communication connection, that sends a connection request to target devices, that detects a response indication from target devices and that controls the switch matrix to establish communication connections.

2. The communication system of claim 1, further comprising:
a telephone interface, coupled to the switch matrix and the controller, that enables communication connections with an external phone system; and
wherein the controller is able to establish a communication connection between a technician communicator and a phone type device coupled via the telephone interface.

3. The communication system of claim 2, wherein the controller detects a request indication by a technician communicator to establish a communication connection with a telephone device.

4. The communication system of claim 2, wherein the controller automatically determines a request by a technician communicator to establish a communication connection with a telephone device by the format of a request transmitted by the technician communicator (e.g., detects a regular phone number and automatically links to an outside line.).

5. The communication system of claim 2, wherein the controller determines that a target technician communicator is offline or busy, and redirects the request to a telephonic device via the telephone interface (e.g. forwards to a phone or voicemail).

6. The communication system of claim 1, further comprising:
a network interface, coupled to the switch matrix and the controller, that enables communications with an external data network; and
wherein the controller is able to establish a communication connection between a technician communicator and a data device coupled via the network interface.

7. The communication system of claim 6, wherein the controller detects a data connection request from a technician communicator.

8. The communication system of claim 6, wherein the network interface is configured according to an Ethernet standard for enabling Ethernet communications.

9. The communication system of claim 1, wherein the requests by technician communicators comprise an identifier transmitted by a first technician communicator that identifies a second technician communicator.

10. The communication system of claim 9, wherein the identifier comprises a plurality of alphanumeric digits.

11. The communication system of claim 9, wherein the controller includes a database of technician communicators, the database listing each authorized technician communicator and a corresponding identifier, and wherein the controller determines if the target technician communicator is online.

12. The communication system of claim 1, wherein the controller detects a data request indication from a technician communicator indicating a data communication connection.

13. The communication system of claim 1, wherein the controller implements a conference channel that enables full duplex communication between at least three technician communicators on the same channel.

14. The communication system of claim 1, wherein the central communicator is configured as a rack mountable device having a front panel.

15. The communication system of claim 1, wherein the controller detects whether technician communicator are online via connection control indications.

16. A cable technician communicator that is configured as a hand-held unit and that enables voice and data communications across a cable network, comprising:
a cable connector;
a diplex filter coupled to the cable connector;
a transceiver circuit, coupled to the diplex filter, that tunes to selected downstream and upstream channels signals;
an audio circuit, coupled to the transceiver circuit, that enables bidirectional voice communications using the selected downstream and upstream channels signals via the cable network;
a control circuit, coupled to the transceiver circuit and the audio circuit, that establishes a communication link and that initiates and terminates communications.

17. The cable technician communicator of claim 16, wherein the transceiver circuit comprises:
a downstream tuner that tunes to a selected downstream RF channel and a demodulator that converts an IF signal to a receive baseband signal; and
an IF modulator that modulates a transmit baseband signal and an RF modulator that asserts an RF transmit signal incorporating the transmit baseband signal onto an appropriate frequency range of the selected upstream channel.

18. The cable technician communicator of claim 15, further comprising:
a data interface circuit, coupled to the transceiver circuit and the control circuit, that enables bidirectional data communications using the selected downstream and upstream channels signals via the cable network.

19. The cable technician communicator of claim 18, wherein the data interface circuit includes a USB port.

20. The cable technician communicator of claim 18, wherein the data interface circuit includes a serial port.

21. The cable technician communicator of claim 18, wherein the data interface circuit includes an infrared port.

22. The cable technician communicator of claim 18, wherein the data interface circuit enables coupling to an infrared-capable device.

23. The cable technician communicator of claim 16, further comprising:
a VOX circuit and headset connector, coupled to the control circuit and the audio circuit, that receives a headset.

24. The cable technician communicator of claim 16, further comprising a battery, regulator and charging circuit.

25. The cable technician communicator of claim 16, wherein the transceiver circuit is configured with a downstream tuner that tunes to any one of a plurality of downstream channels within the frequency range of 50 to 860 megahertz (MHz) and an upstream tuner that tunes to any one of a plurality of upstream channels within the range 5 to 65 MHz.

26. The cable technician communicator of claim 25, wherein upstream and downstream communications employ 5 MHz channels.

27. The cable technician communicator of claim 26, wherein the 5 MHz channels are centered within 6 MHz cable channels.

28. The cable technician communicator of claim 26, wherein the each channel is further sub-divided into a plurality of sub-channels.

29. The cable technician communicator of claim 16, further comprising:
a touch pad and display; and
a touch pad and display interface, coupled to the touch pad and the display and the control circuit.

30. The cable technician communicator of claim 16, further comprising an on/off hook indicator.

31. The cable technician communicator of claim 16, further comprising an encryption unit for encrypting communications.

32. The cable technician communicator of claim 16, further comprising a call indication and an on/off hook mechanism for answering a call.

33. The cable technician communicator of claim 16, wherein the control circuit is configured to establish communications with a central unit by sending an announce indication via an upstream channel and detecting an acknowledge from the central unit via an acknowledge.

34. The cable technician communicator of claim 33, wherein the control circuit determines a downstream control channel from the central unit which identifies an upstream channel and that sends additional communication and administrative information.

35. The cable technician communicator of claim 34, wherein the control circuit is configured to scan and examine each downstream channel to determine the control channel.
